(19) United States
(12) Patent Application Publication
(10) Pub. No.: US 2002/0148344 A1
(43) Pub. Date: Oct. 17, 2002

(54) Arrangement made to an audio visual device connected to internet

(76) Inventors: Daniel Kenji Tokuzumi, Novembro (BR); Wilson Wagner Mello, Butanta (BR)

Correspondence Address: Striker Striker & Stenby, 103 East Neck Road, Huntington, NY, 11743, US

(21) Appl. No.: 10/089,828

(22) PCT Filed: Jul. 25, 2001
(86) PCT No.: PCT/BR01/00089

(30) Foreign Application Priority Data
Sep. 7, 2000 (BR) MU 8001707-0

(51) Int. Cl. G09B 5/00; G09B 15/04

(52) U.S. Cl. 84/609; 434/307 A

(57) ABSTRACT

“AN ARRANGEMENT MADE TO AN AUDIO VISUAL DEVICE CONNECTED TO INTERNET” being constituted of an audio visual device of Karaoke (1) that works in a way similar to other devices and can be connected to a TV set as the usual equipment is connected and said equipment was exclusively developed to be connected to Internet, which is used both via satellite, Cable TV, radio, medium and short waves or telephone line and to only one Site specially adapted to offer several advantages amongst them we could cite that user can buy songs by units therefore avoiding to be subjected to cartridges and CDs; and said user can further get a sound and image quality even better than those offered by the usual systems; in addition to this, the launches of songs on the market that were not quickly available for the ancient equipment can now be immediately obtained through an uncommon way; to have such songs via Internet, user shall make “download” through a simplified procedure; this makes the equipment to be a device easily handled, much more efficient and with a cost lower than any traditional pattern; the internal construction of said equipment requires a Modem and a computer system to provide the connections of said equipment to the dedicated Site, the equipment is also externally provided with connection buttons (2), navigation buttons (3), sound and image regulating buttons (4), microphone ancillary inputs (5), Leds and Audio Visual devices (6); in order to make possible the connection to Internet and the perfect working of said device (1), it has been provided with a power cable (7), telephone line input (8), video output (9) and ancillary input for audio and video (10).

“AN ARRANGEMENT MADE TO AN AUDIO VISUAL DEVICE CONNECTED TO INTERNET” the purpose of which is a practical and innovating pattern of Karaoke, belonging to electronic equipment field, and to be used substantially for entertainment and leisure. Such device was given an original constructive arrangement in order to improve the use and performance thereof in connection with other patterns commonly found on the market.

Therefore according to this application for a letter patent, an equipment is specially designed and developed to be much more practical and advantageous both when used and manufactured.

The object of this application is further to get a pattern of karaoke being manufactured with very low costs in addition to having some requirements of strength, safety and practical quality, thereby offering the consumer an additional option on the market of congenerous articles.

As it is of the public knowledge said entertainment and leisure device called Karaoke refers to an electronic equipment that when connected to a TV set or a Video Cassette helps the user thereof to practice his singer abilities because such equipment shall only provide instrumental sound and show the words of the relevant song on the video.

As it is known mainly by owners of such devices in the present stage a new equipment has a Cartridge, a CD, a “Chip” for memory or finally some data source with thousand or more songs.

In its common form, when user wants to practice new or more recent songs or some songs not recorded in the original memory of said equipment, user shall have to buy on the market a new data source being compatible with his equipment and new songs recorded in same.

Such patterns are very improper specifically due the fact that as the electronics is developed very quickly the cartridges for ancient devices cannot be found on the market thereby obliging user to buy a new equipment besides being very boring to look for new cartridge in specialized shops.

After several searches and studies and taking into account such troubles the inventor being someone engaged in such a field has created and developed the object hereof. He designs a Karaoke equipment in which not only its mechanic and functional qualities were taken into account in its design aiming at its manufacture but also the form, arrangement and location of its parts and components that when rightly placed caused the efficiency to be increased without any additional cost.

This way, this patent was designed to manufacture an equipment having a lower number of pieces as possible properly configured and arranged to allow the device in question to perform its functions with an efficiency and versatility never reached before, without the already mentioned troubles.

It is shown in this application for a patent, a practical and innovating pattern of Karaoke with all of aesthetical and functional qualities thereof being designed and developed under the most modern techniques thereby making it possible to be extensively used, that is to say to be used by means of the traditional system connected to a TV set or connected to Internet or else in other different ways.

The innovating pattern of this device shall allow that an excellent level of functionality is obtained, offering this way a Karaoke pattern having a very long useful life and it was created mainly to facilitate the replacement or acquisition of new songs, so an always updated feature shall be added to such product.

The configuration of said equipment, object of this patent, comprises in its constructive form a Karaoke equipment connected to Internet being used either via satellite, Cable TV, radio, medium and short waves or telephone line, so that when user shall wish new songs, the only thing he has to do is to provide the proper commands and the equipment itself shall be able to “buy” new songs, by unit or package, through a Site specially designed for “selling” such songs.

It is understood that the equipment in question is very simple as far as its construction is concerned therefore it can easily be manufactured, but excellent practical and functional results are obtained thereby offering an innovating pattern if compared with the known patterns.

It was created with an innovating design that results in a harmonic assembly with a very proper and characteristic aspect; said pattern besides its constructive form, it is distinguished by its usage versatility and suitability.

To better understand and know how said “ARRANGEMENT MADE TO AN AUDIO VISUAL DEVICE CONNECTED TO INTERNET” as applied for herein the illustrative drawings attached hereto are shown as follows:

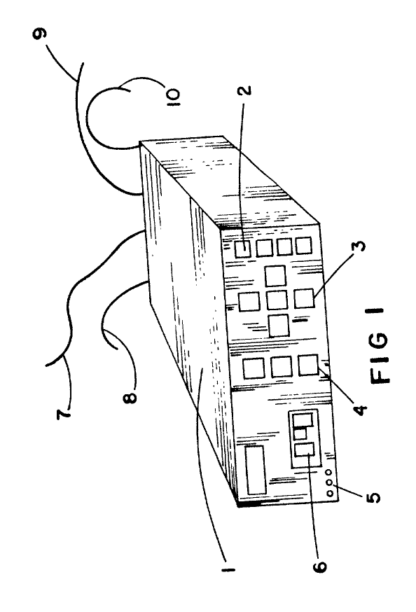

FIG. 1—Shows an exemplary perspective view of a possible construction of the now claimed equipment.

According to what is shown by the above listed figures, the “ARRANGEMENT MADE TO AN AUDIO VISUAL DEVICE CONNECTED TO INTERNET”, object hereof, is essentially s characterized by being constituted of an audio visual device of Karaoke (1) that works in a way similar to other devices and can be connected to a TV set as the usual equipment is connected. Said equipment was exclusively developed to be connected to Internet, which is used both via satellite, Cable TV, radio, medium and short waves or telephone line and to only one Site specially adapted to offer several advantages amongst them we could cite that user can buy songs by units therefore avoiding to be subjected to cartridges and CDs; and said user can further get a sound and image quality even better than those offered by the usual systems; in addition to this, the launches of songs on the market that were not quickly available for the ancient equipment can now be immediately obtained through an uncommon way.

To have such songs via Internet, user shall make “download” through a simplified procedure; this makes the equipment to be a device easily handled, much more efficient and with a cost lower than any traditional pattern.

The internal construction of said equipment requires a Modem and a computer system to provide the connections of said equipment to the dedicated Site, the equipment is also externally provided with connection buttons (2), navigation buttons (3), sound and image regulating buttons (4), microphone ancillary inputs (5), Leds and Audio Visual devices (6).

In order to make possible the connection to Internet via satellite, Cable TV, medium and short waves radio or telephone line and the perfect working of said device (1), it has been provided with a power cable (7), telephone line input (8), video output (9) and ancillary input for audio and video (10).

Therefore this embodiment described a new conception of an electronic equipment of “Videoke” interconnected to Internet via satellite, Cable TV, medium and short waves radio or telephone line, having as we could demonstrate through the analysis performed and figures shown several differences in relation to those usual patterns existing on the consumer market in addition to technical constructive and functional characteristics entirely different from those found in the prior art. Due to the advantages it offers and the features thereof which actually are innovating, this “ARRANGEMENT MADE TO AN AUDIO VISUAL DEVICE CONNECTED TO INTERNET”, has the necessary conditions to be given a Letter Patent for an Utility Model.

1. “AN ARRANGEMENT MADE TO AN AUDIO VISUAL DEVICE CONNECTED TO INTERNET” is essentially characterized by being constituted of an audio visual device of Karaoke (1) that works in a way similar to other devices and can be connected to a TV set as the usual equipment is connected and said equipment was exclusively developed to be connected to internet, which is used both via satellite, Cable TV, radio, medium and short waves or telephone line and to only one site specially adapted to offer several advantages amongst them we could cite that user can buy songs by units therefore avoiding to be subjected to cartridges and CDs; and said user can further get a sound and image quality even better than those offered by the usual systems; in addition to this, the launches of songs on the market that were not quickly available for the ancient equipment can now be immediately obtained through an uncommon way; to have such songs via internet, user shall make “download” through a simplified procedure; this makes the equipment to be a device easily handled, much more efficient and with a cost lower than any traditional pattern; the internal construction of said equipment requires a modem and a computer system to provide the connections of said equipment to the dedicated site, the equipment is also externally provided with connection buttons (2), navigation buttons (3), sound and image regulating buttons (4), microphone ancillary inputs (5), Leds and Audio Visual devices (6); in order to make possible the connection to internet and the perfect working of said device (1), it has been provided with a power cable (7), telephone line input (8), video output (9) and ancillary input for audio and video (10).
